(19) United States
(12) Patent Application Publication
(10) Pub. No.: US 2004/0095962 A1
(43) Pub. Date: May 20, 2004

(54) Data routing device, method for determining a destination of a request, and a computer program product for realizing the method

(75) Inventor: Takayuki Ohta, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Allied Telesis K.K., Tokyo (JP)

(21) Appl. No.: 10/345,172

(22) Filed: Jan. 16, 2003

(30) Foreign Application Priority Data
Nov. 14, 2002 (WO) PCT/JP02/11883

(51) Int. Cl. H04J 3/24

(52) U.S. Cl. 370/475; 370/389

(57) ABSTRACT

A routing device interconnects a client and a first DNS server resolving a virtual domain name on a local network or a second DNS server resolving an actual domain name on the internet. The routing device has a DNS server designation section designating the first DNS server if an inputted domain name matches a virtual domain name stored in relation to an IP address of the first DNS server, and designating the second DNS server if it does not.

### BACKGROUND OF THE INVENTION

1. Field of the Invention

The present invention relates to a data routing device, a method for determining a destination of a request, and a computer program product for realizing the method.

2. Related Background Art

Recently, various kinds of servers have been employed in building a vast network such as an internet. One of those servers is a Domain Name System (DNS) server that performs conversion between a domain name and an Internet Protocol (IP) address. Receiving a query about a domain name or an IP address from a client, the DNS server responds to the client by supplying an IP address corresponding to the domain name or a domain name corresponding to the IP address.

The network technology is applied to building of an intranet incorporating a Local Area Network (LAN) or Wide Area Network (WAN). For example, the DNS server is employed in the intranet also. In this case, the DNS server performs name resolution between a virtual domain name used in the intranet and an IP address. The virtual domain name in the intranet is assigned for the intranet use only, which is different from one for the internet.

A network generally has a router that forwards data on one network to another. The router interconnects the internet and the intranet, for instance, and forwards the data over a most efficient available route.

Name resolution processing in the DNS is generally as follows. First, the router receives query data requesting the name resolution from a client. The query data include a host domain name to be resolved. The data also include an IP address of the router as a destination address, and a flag to indicate that the name resolution is requested. The router then rewrites the data so that the destination address is set to an IP address of a predetermined DNS server, and transfers the data to the DNS server. Receiving the query data, the DNS server resolves the domain name, and transmits an answer to the router.

However, the DNS server on the internet is capable of resolving actual domain names used on the internet, but incapable of resolving virtual domain names used on the intranet. On the other hand, the DNS server on the intranet is capable of resolving virtual domain names on the intranet, but incapable of resolving domain names on the internet.

The client makes a request for the name resolution to a predetermined DNS server. The client sets both the DNS server on the internet and the DNS server on the network using the virtual domain name, as DNS servers to which the request is to be forwarded. However, when either of the DNS servers reports that it has been unable to resolve the name, the name resolution processing ends at that time. For example, in a case where both the DNS servers are queried about the same domain name, once a failure report is sent from either of them, neither of the DNS servers are able to perform the name resolution after that. As explained above, a conventional system has a problem of being unable to ensure the name resolution processing for virtual domains on the intranet and actual domains on the internet.

The present invention has been accomplished to solve the above problem and an object of the present invention is thus to provide a data routing device, a method for determining a destination of query data, and a computer program product for realizing the method, which ensure name resolution processing for domain names including virtual domain names.

### SUMMARY OF THE INVENTION

A data routing device according to the present invention is a data routing device for routing a request to plural resolution systems to supply address information corresponding to address information on a network; having an obtaining unit of obtaining a request including address information on the network and demanding address information corresponding to the address information on the network; a storing unit of storing resolution system information regarding the plural resolution systems, and associated with the address information on the network; a determining unit of determining a resolution system to which the request is to be forwarded among the above plural resolution systems, based on the address information on the network included in the request and the resolution system information stored in the storing unit; and a transmitting unit of transmitting the request to the resolution system determined. This configuration makes sure to forward the request to the system capable of replying.

Of the above address information on the network and the corresponding address information, one is a domain address and the other is an IP address. This ensures the name resolution between the domain address and the IP address.

The plural resolution systems may include a DNS server performing name resolution between a domain address and an IP address. This configuration makes certain to forward the request for the name resolution to the predetermined DNS server.

The storing unit may have first resolution system information associated with a domain address on the network using a virtual domain or to an IP address, and second resolution system information associated with a domain address on the network using an actual domain or to an IP address. This configuration makes it possible to forward the request to the resolution system capable of replying in accordance with a virtual or actual domain.

The first resolution system may include a name server to perform name resolution in the virtual domain, and the second resolution system may include a name server to perform name resolution in the actual domain. This configuration makes it possible to forward the request to the resolution system capable of replying in accordance with a virtual or actual domain.

The address information on the network and the corresponding address information may indicate an address of the same node.

The resolution system information may include address information of a name server performing the name resolution. This configuration makes sure to forward the request to the name server capable of resolving the name in accordance with requested address information.

The storing unit may have first resolution system information associated with a local address, and second resolution system information related a global address. This configuration makes it possible to forward the request to the resolution system capable of replying in accordance with a local or global address.

The first resolution system information may include address information of a name server to resolve the local address, and the second resolution system information may include address information of a name server to resolve the global address. This configuration makes certain to forward the request to the appropriate name server in accordance with a local or global address.

A method for determining a destination of a request according to the present invention is a method having a step to store resolution system information regarding plural resolution systems to supply address information corresponding to address information on a network; a step to obtain a request including the address information on the network and demanding address information corresponding to the address information on the network; and a step to determine a resolution system to which the request is to be forwarded among the plural resolution systems, based on the address information on the network included in the obtained request, and the stored resolution system information. This configuration makes sure to forward the request to the system capable of replying.

The storing step may have a step to store first resolution system information associated with a domain address on the network using a virtual domain or to an IP address, and second resolution system information associated with a domain address on the network using an actual domain or to an IP address. This configuration makes it possible to forward the request to the resolution system capable of replying in accordance with a virtual or actual domain.

A program for a computer to carry out a processing for determining a destination of a request according to the present invention is a program to run on a computer, having a step to store resolution system information regarding plural resolution systems to supply address information corresponding to address information on a network; a step to obtain a request including the address information on the network and demanding address information corresponding to the address information on the network; and a step to determine a resolution system to which the request is to be forwarded among the plural resolution systems, based on the address information on the network included in the obtained request, and the stored resolution system information. This configuration makes certain to forward the request to the system capable of replying.

The storing step may have a step to store first name server address information associated with a domain address on a network using a virtual domain or to an IP address as resolution system information; and a step to store second name server address information associated with a domain address on a network using an actual domain or to an IP address as resolution system information. This configuration makes it possible to forward the request to the resolution system capable of replying in accordance with a virtual or actual domain.

The present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a schematic diagram showing a configuration example of a DNS relay system employing a data routing device according to the present invention.

FIG. 2 is a block diagram showing a configuration example of a client and a DNS server.

FIG. 3 is a flowchart showing a processing flow example of a DNS relay system employing the data routing device according to the present invention.

FIG. 4 is a block diagram showing a configuration example of the data routing device according to the present invention.

FIG. 5 is a block diagram showing a configuration example of the data routing device according to the present invention.

FIGS. 6A and 6B are schematic diagrams showing an example of a routing table stored in the data routing device according to the present invention.

FIG. 7 is a flowchart showing a processing flow example of the data routing device according to the present invention.

FIGS. 8A, 8B, 8C, and 8D are schematic diagrams showing data transmitted from and received in the DNS relay system employing the data routing device according to the present invention.

FIG. 9 is a schematic diagram showing another configuration example of the DNS relay system employing the data routing device according to the present invention.

FIG. 10 is a block diagram showing another configuration example of the data routing device according to the present invention.

FIG. 11 is a flowchart showing another processing flow example of the data routing device according to the present invention.

FIG. 12 is a schematic diagram showing another configuration example of the DNS relay system employing the data routing device according to the present invention.

### DESCRIPTION OF THE PREFERRED EMBODIMENTS

The preferred embodiments of the present invention will be described hereinafter in detail with reference to the accompanying drawings.

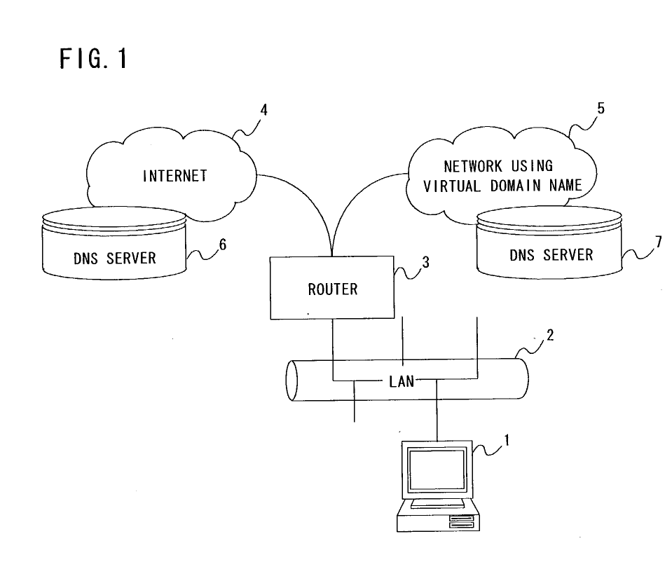

A configuration example of a DNS relay system employing a data routing device in accordance with the present embodiment will be explained with reference to FIG. 1. FIG. 1 is a schematic diagram showing a configuration example of a DNS relay system according to the present embodiment. In FIG. 1, reference number 1 denotes a client to request to resolve a domain address, referred to as a domain name. Reference number 2 denotes a LAN, 3 a router to route received data, 4 the internet, and 5 a network using a virtual domain. Further, reference numbers 6 and 7 denote resolution systems, referred to as DNS servers, to resolve names based on the query data from the client 1. From a domain address or an IP address, which is the received address information, the DNS servers 6 and 7 are able to supply an IP address corresponding to the domain name or a domain name corresponding to the IP address.

The router 3 is, as shown in FIG. 1, connected with the client 1 on the LAN 2 so that they can communicate with each other. The router 3 and the client 1 may be connected with each other on a WAN. The router 3 is also connected with the DNS server 6 through the internet 4, and with the DNS server 7 through the network 5 using the virtual domain. The network 5 using the virtual domain may be a local network such as an intranet built with LAN or WAN.

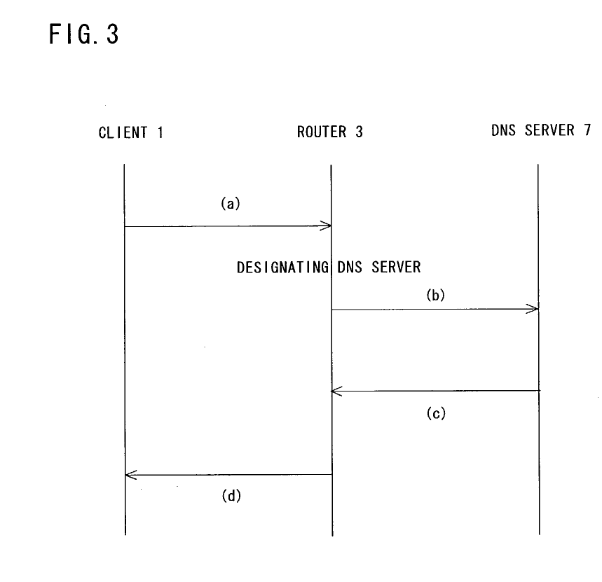

FIG. 3 schematically explains an example of a processing flow of a DNS relay system employing the data routing device according to the present invention. As in FIG. 3, the client 1 submit a query to the router 3 about a domain name (FIG. 3A). Being unable to resolve the domain name, the router 3 designates the DNS server 6 or 7, and queries the designated server about the domain name (FIG. 3B).

The DNS server 6 or 7 then resolves the domain name, and transmits an IP address corresponding to the domain name to the router 3 (FIG. 3C). Receiving the IP address, the router 3 forwards it to the client 1 (FIG. 3D). The client 1 thereby obtains the requested IP address.

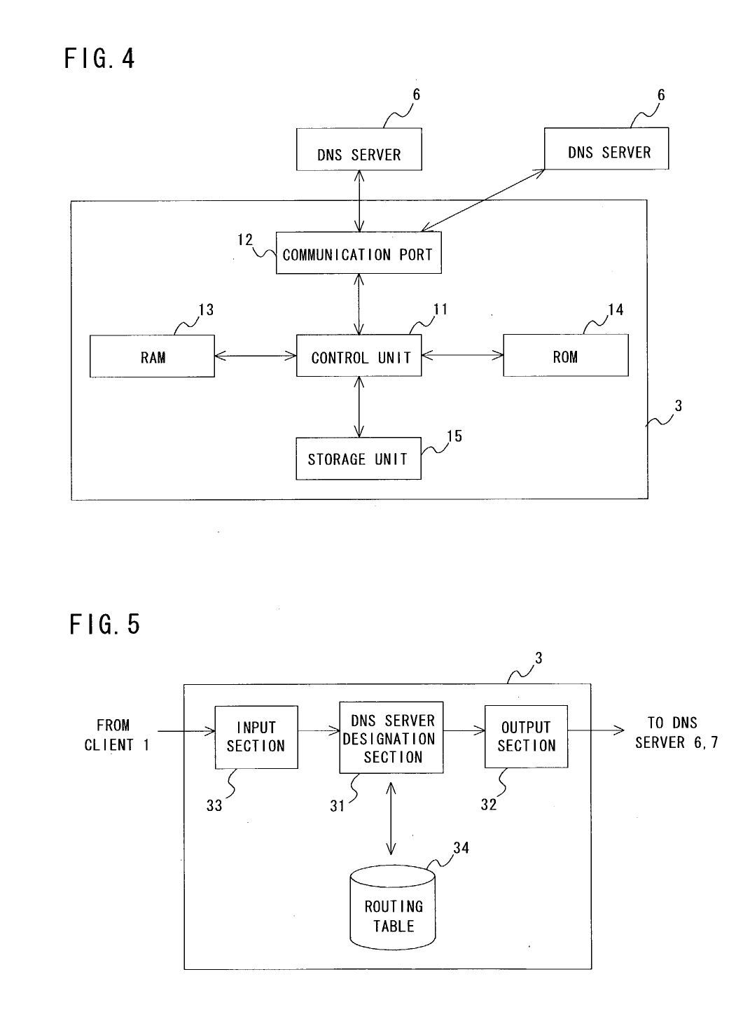

A routing device according to the present invention will be now explained with reference to FIG. 4. The explanation will be given of the case where the present invention is applied to the router 3 having a function to control a communication path. The present invention, however, may be applied also to other network devices to interconnect networks. The network devices include a hub, switch or other concentrators, repeater, bridge, gateway, a wireless repeater such as an access point that is a routing device of a wireless LAN, and a game device having a communication function, for example. Further, as explained later, a routing device according to the present invention may be a personal computer (PC) or sever.

FIG. 4 is a block diagram showing an example of a hardware configuration of the router 3. As in FIG. 4, the router 3 is provided with a control unit 11, communication port 12, random access memory (RAM) 13, read only memory (ROM) 14, and storage unit 15. The control unit 11, a processing unit such as a central processing unit (CPU) or microprocessing unit (MPU), controls each section of the router 3. The control unit 11 runs programs stored in ROM 14 or the storage unit 15 in cooperation with RAM 13, ROM 14, the storage unit 15, and other sections. The communication port 12 is an interface to be connected to another network. The communication port 12 includes a LAN adapter for being connected to a network, and a USB port or an IEEE 1294 port for being connected to dedicated lines such as a public telephone line for being connected to the internet, an integrated services digital network (ISDN) with a modem, terminal adapter (TA), and so on. The RAM 13 temporarily stores data read out of the ROM 14 or the storage unit 15, and data to be written into the storage unit 15. The ROM 15 stores software which are necessary for operation of the control unit 11, and other software including firmware. The storage unit 15 stores computer programs and data including communication parameters, setting programs, and DNS server designation programs. The DNS server designation program is, as explained later on, a program to specify a DNS server to resolve domain addresses or IP addresses. The setting program sets data which are necessary for communication.

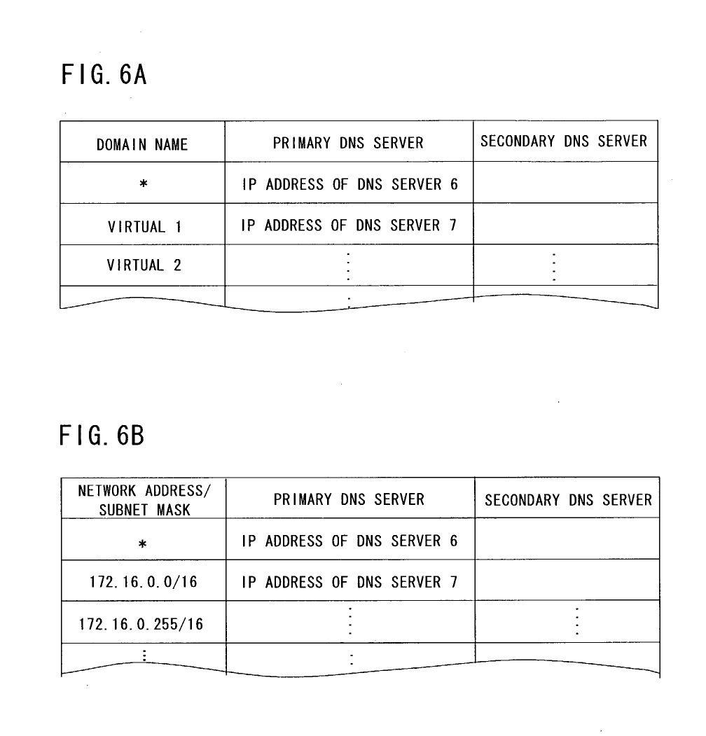

The router 3 will be explained hereinafter in detail with reference to FIGS. 5 and 6. FIG. 5 is a block diagram schematically showing a logic configuration of the router 3. FIG. 5 illustrates the structures of logic elements such as computer programs to be executed by the hardware configuration explained in FIG. 4 or logic cirtuits. As shown in FIG. 5, the router 3 is provided with a DNS server designation section 31, an output section 32, and an input section 33. The DNS server designation section 31 designates the DNS server 6 or 7 with reference to a routing table 34. The output section 32 sends inputted query data requesting the name resolution of a domain name or IP address to the DNS server 6 or 7 designated by the DNS server designation section 31. The input section 33 sends the domain name or IP address included in the query data sent from the client 1 to the DNS server designation section 31.

Next, the routing table 34 to which the DNS server designation section 31 refers will be explained with reference to FIGS. 6A and 6B. FIGS. 6A and 6B are schematic diagrams showing an example of a routing table stored in the storage unit 15. The routing tables shown in FIGS. 6A and 6B are preset configuration data prestored to the router 3. The configuration data are set in the same way as other function data of the router 3, for instance.

The routing table 34 stores domain names or IP addresses associated with the information about the DNS server 6 and 7 corresponding to each of them. The routing table 34 is stored in the storage unit 15, and loaded to RAM for use. A virtual domain name in the present embodiment is a domain name used on a local network, and an actual domain name is a domain name used on the internet.

FIG. 6A shows a table including items of plural domain names and address information of the DNS servers 6 and 7 associated with those names. In FIG. 6A, a virtual domain name “virtual 1” is associated with an IP address of the DNS server 7 as a primary DNS server. The virtual domain name “virtual 1” is a specific domain name of a host in a local network 5 of the DNS server 7. The IP address of the DNS server 7 corresponding to the virtual domain name “virtual 1” is a global address that is unique to the DNS server or its communication interface. The IP address of the DNS server may be replaced with other information allowing the query data to be forwarded to the DNS server.

In addition, a secondary DNS server corresponding to the virtual domain name “virtual 1” may be the DNS server 7 as is the case with the primary server, or another DNS server in the local network 5.

On the other hand, a domain name “*” is associated with the IP address of the DNS server 6. The domain name “*” is a default value corresponding to all the domain names except those included in the routing table 34. The default value here indicates any domain name of a host on the internet 4, which is an actual domain name on the internet 4. The IP address of the DNS server 6 corresponding to the domain name “*” is a global address that is unique to the DNS server or its communication interface. Further, a secondary server corresponding to the domain name “*” may be another DNS server on the internet 4, as is a conventional case.

FIG. 6B shows a routing table exhibiting correspondence between IP addresses and the DNS server 6 or 7. In FIG. 6B, a network address/subnet mask “172.16.0.0/16” is associated with the IP address of the DNS server 7 as a primary DNS server. The network address/subnet mask “172.16.0.0/16” is a specific private address of a host in the local network 5 of the DNS server 7. The IP address of the DNS server 7 corresponding to the network address/subnet mask “172.16.0.0/16” is a global address that is unique to the DNS server or its communication interface.

Further, a secondary. DNS server corresponding to the network address/subnet mask “172.16.0.0/16” may be the DNS server 7 as is the case with the primary server, or another DNS server in the local network 5.

On the other hand, a network address/subnet mask “*” is associated with the IP address of the DNS server 6. The network address/subnet mask “*” is a default value corresponding to all the domain names except those included in the routing table 34. The default value here indicates a random IP address of a host on the internet 4. The IP address of the DNS server 6 corresponding to the network address/subnet mask “*” is a global address that is unique to the DNS server or its communication interface.

A secondary server corresponding to the network address/subnet mask “*” may be another DNS server on the internet 4, as is a conventional case. The routing table 34 may have items of plural virtual domains or actual domains, and the DNS servers corresponding to each of them. Instead of employing the above table, it is also possible to perform a given operation for calculating the DNS server address in order to decide a destination DNS server from address information included in the query data.

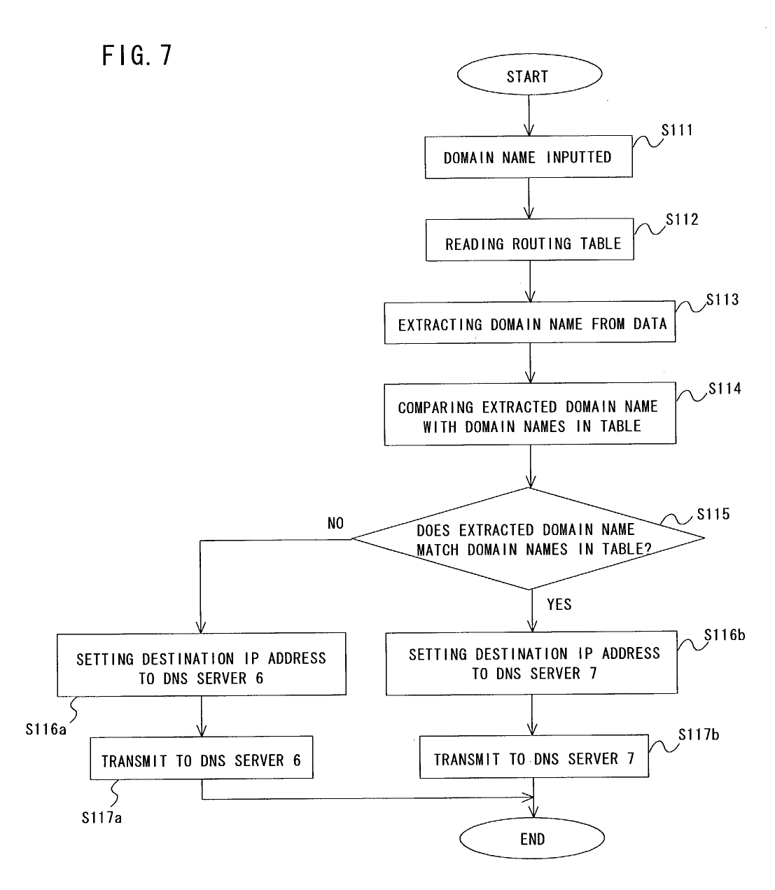

A process in which the router 3 decides a destination of the query data requesting the name resolution sent from the client will be now detailed with reference to FIGS. 5 and 7. FIG. 7 is a flowchart showing a processing flow example of the router 3. FIG. 7 explains a case where name resolution from a domain name to an IP address is requested to the DNS server 6 or 7. The process is basically the same in a case where name resolution from an IP address to a domain name is requested to the DNS server 6 or 7.

As shown in FIG. 7, when the router 3 receives query data including a domain name from the client 1, the received query data are inputted to the DNS server designation section 31 via the input section 33, for example (S111).

When the query data including the domain name are inputted to the DNS server designation section 31, the routing table 34 is loaded to RAM 13 from the storage unit 15 (S112). Here, in a case where name resolution from a domain name to an IP address is requested to the DNS server 6 or 7, the routing table shown in FIG. 6A is used.

The DNS server designation section 31 extracts the domain name from the received query data (S113) The DNS server designation section 31 then compares the extracted domain name with domain names in the routing table 34 (S114).

If the comparison results in that the extracted domain name does not match any domain name in the routing table 34, the domain name is equivalent to the default domain name “*”; therefore, the DNS server designation section 31 decides to transmit the query data to the DNS server corresponding to “*”. Then, an IP header of the query data is rewritten so that a destination IP address is changed from the IP address of the router 3 to that of the DNS server 6 (S116a). A sender IP address in the IP header is also changed from the IP address of client 1 to that of the router 3b. The query data requesting the name resolution of the domain name are then transmitted to the DNS server 6 via the output section 32 (S117a).

On the contrary, in a case where the extracted domain name matches a domain name in the routing table 34, and if it is the virtual domain name “virtual 1” for example, the DNS server designation section 31 decides to transmit the query data to the DNS server corresponding to “virtual 1”. The IP header of the query data is rewritten so that the destination IP address is changed from the IP address of the router 3 to that of the DNS server 7 (S116b). Also, the sender IP address in the IP header is changed from the IP address of the client 1 to that of the router 3. Then, the query data requesting the name resolution of the virtual domain name are transmitted to the DNS server 7 via the output section 32 (S117b)

The DNS server designating server 31 in the present embodiment sequentially compares the domain name in the query data with each of the domain names in the routing table 34 so as to determine whether the domain name in the query data is virtual or actual. Based on the decision, the DNS server designating server 31 designates the DNS server 6 or 7. Alternatively, the DNS server designating server 31 may designate the DNS server 7 when the domain name matches the virtual domain name in the routing table 34, and designate the DNS server 6 when it does not.

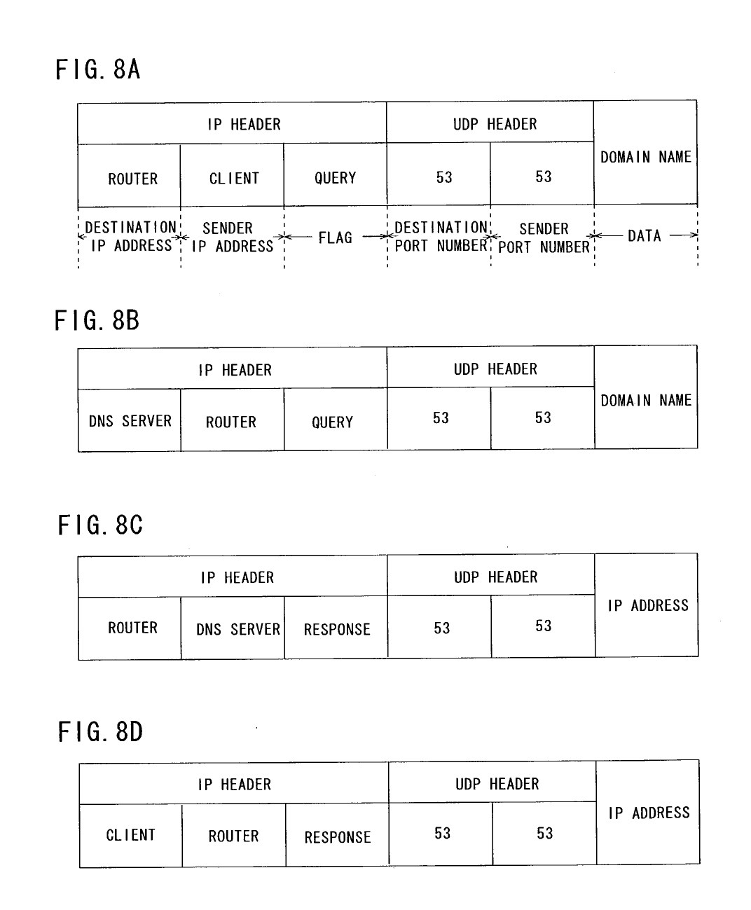

Now, a data flow of a DNS relay system according to the present invention will be explained with reference to FIGS. 3 and 8. FIGS. 8A, 8B, 8C, and 8D are schematic diagrams showing data transmitted from and received in the DNS relay system. Though the explanation here will be given of a case where the client 1 requests for the name resolution of a domain name, a case where the request is for the name resolution of an IP address is processed in the same manner.

In the client 1, a domain name of “www.XXX”, for example, is inputted on browser via an external input unit. By a resolver of the client 1, the inputted domain name is included in query data whose sender is the client 1 and whose destination is the router 3, and transmitted to the router 3.

The query data transmitted from the client 1 to the router 3 are produced based on a user datagram protocol (UDP) and internet protocol (IP). A packet of the data includes a domain name, an UDP header having port numbers of the sender and destination, and an IP header having IP addresses of the sender and destination, and a flag. A protocol in a transport layer may be a transmission control protocol (TCP).

In the IP header of the data transmitted from the client 1 to the router 3, the destination IP address is set to the IP address of the router 3, and the sender IP address is set to that of the client 1 (FIG. 8A). The IP header has the flag indicating a query. In the UDP header, a destination port number and a sender port number are set to 53 (NAMESERVER) indicating name resolution.

Receiving the query data, the router 3 recognizes the data to be a query from the flag of the IP header. The router 3 further recognizes that the destination port number of the UDP header is 53 indicating name resolution, thereby deciding that the name resolution has been requested by the client 1.

Being incapable of the name resolution, the router 3 designates a DNS server to which the name resolution is allocated in accordance with the DNS server designation section 31. The router 3 then transmits the query data to the designated DNS server 6 or 7. The router 3 also adds to the query data identification (ID) to relate the query data sent from the client 1 to response data to be sent from the DNS server.

The router 3 rewrites the query data sent from the client 1 so that the destination IP address in the IP header is set to the IP address of the designated DNS server, and the sender IP address is set to that of the router 3 (FIG. 8B). The query data have the flag in the IP header indicating the query, and the destination and sender port numbers in the UDP header indicating 53 to signify the name resolution.

If the domain name sent from the client 1 is found in the routing table, the DNS server designation section designates the DNS server 7. In the following, a case where the designated DNS server is the DNS server 7 will be explained.

Receiving the query data requesting the name resolution from the router 3, the DNS server 7 resolves the domain name in the query data, converting it into a corresponding IP address. The DNS server 7 then adds the UDP header and the IP header to the located IP address corresponding to the domain name, and transmits the response data to the router 3 (FIG. 8C).

The destination and sender port addresses in the UDP header are set to 53 indicating the name resolution, and the sender IP address in the IP header is set to an IP address of the DNS server 7, and the destination IP address is set to that of the router 3. The flag in the IP header is set to “response”.

Receiving the response data, the router 3 recognizes the data as a response from the flag of the IP header. The router 3 then recognizes that the destination port number of the UDP header is 53 signifying the name resolution, thereby determining that the response to the name resolution has been made by the DNS server 7. The router 3 then determines which query data the response is for, from the ID included in the response data.

The router 3 rewrites the response data transmitted from the DNS server 7 so that the destination IP address in the IP header is set to the IP address of the client 1, and the sender IP address is set to that of the router 3 (FIG. 8D). The query data have the flag in the IP header indicating the query, and the destination and sender port numbers in the UDP header indicating 53 to signify the name resolution.

Receiving the response data, the client 1 obtains the IP address located from the domain name. The client 1 then extracts the IP address from the data with the resolver.

As explained in the foregoing, the router 3 designates a DNS server to which the name resolution is allocated out of plural DNS servers based on an inputted domain name.

The router 3 designates the DNS server 6 or 7 with reference to the routing table 34, in accordance with a DNS server designating program. Therefore, it is possible to resolve names without fail, not distinguishing virtual domain names or private IP addresses from actual domain names or public IP addresses. The query data routing process according to the present embodiment is not restricted to be applied to name resolutions of virtual domains and actual domains, but is applicable to name resolutions of other domains. Further, the process is not necessarily applied to name resolutions of domain names, whereas it may be also applied to resolution systems for other address information.

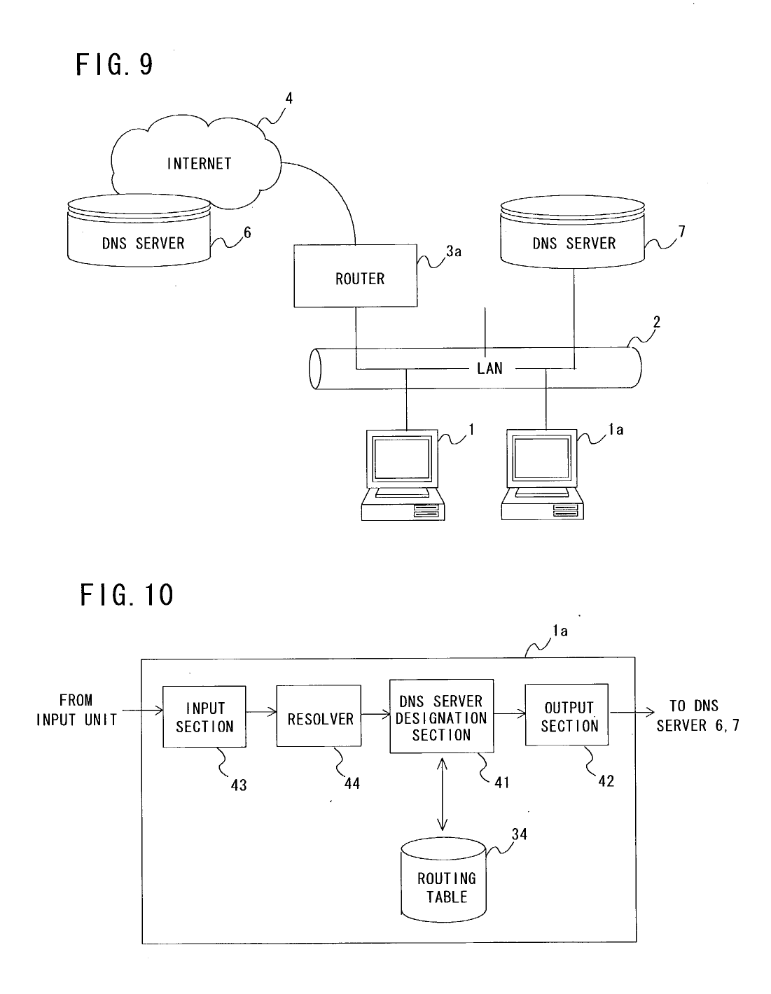

Now, another configuration example of the DNS relay system employing the data routing device according to the present invention will be explained with reference to FIG. 9. FIG. 9 is a schematic diagram showing another configuration example of the DNS relay system according to the present invention. As shown in FIG. 9, the DNS relay system includes clients 1 and 1a, a router 3a, and DNS servers 6 and 7.

The router 3a is a conventional router, which is different from the router 3 in the DNS relay system shown in FIG. 1. The client 1 and the DNS servers 6 and 7 are the same as those shown in FIG. 1. A configuration of the client 1a will be detailed later on.

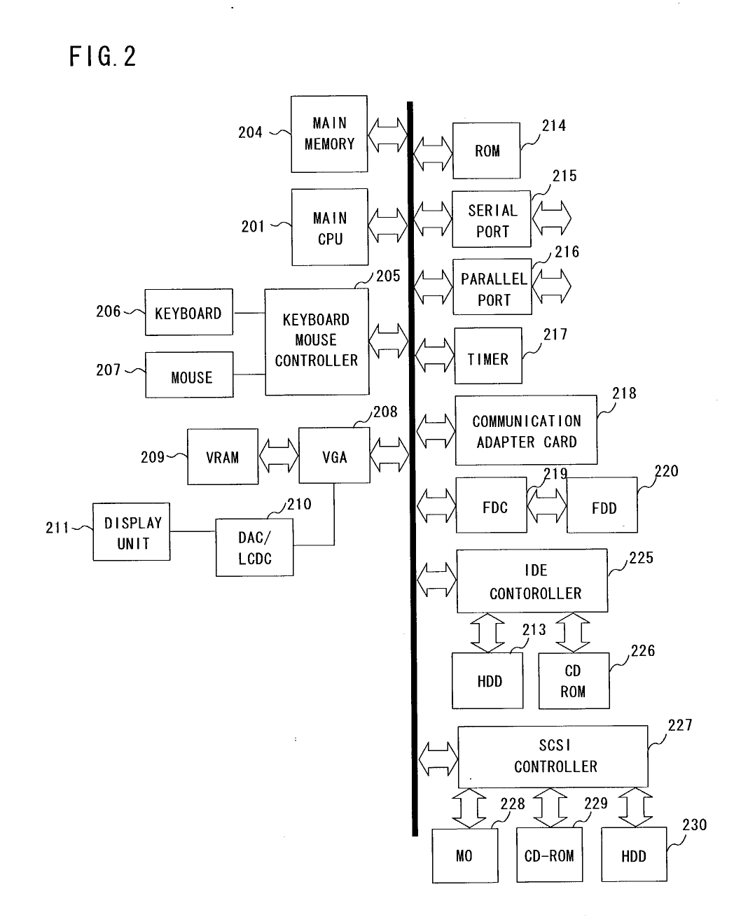

The configuration of the clients 1 and 1a, and the DNS servers 6 and 7 are possible by running necessary client programs or server programs in a general personal computer, work station, notebook personal computer, or various devices with built-in computer, for example. FIG. 2 shows an example of a hardware configuration of the client 1 and the DNS servers 6 and 7 employed in the present embodiment. As shown in FIG. 2, the configuration includes a central processing unit (CPU) 201 and memory 204. The CPU and memory are connected to a hard disk unit 213, an auxiliary equipment, via a bus. Storage medium drive units such as a flexible disk unit 220, hard disk unit 213, and CD-ROM drive 229 are connected to the bus via controllers such as a flexible disk controller 219, IDE controller 225, and SCSI controller 227.

Portable storage medium such as a flexible disk are installed to the flexible disk unit or other storage medium drive units. The storage medium stores a computer program to give a command to the CPU 201 and so on in collaboration with an operating system so as to carry out the present embodiment. The computer program is executed by being loaded into the memory 204. The computer program can be stored in the storage medium by being compressed or broken up into several sections.

The hardware configuration may further include user interface hardware. The user interface hardware include a pointing device (a mouse 207 or a joystick, for example) and a keyboard 206 for input, and a display 211 for presenting visual data to users. A printer can also be connected via a parallel port 216. Further, a modem can be connected via a serial port, and connection with a network is established via the serial port, modem or token-ring, and communication adapter 218, thereby communicating with other computer systems. The configuration is an example, and it is not necessary for the present embodiment to have all the components described here.

FIG. 10 is a block diagram showing a logic configuration example of the client 1a. The logic configuration is made possible by running a software program on the hardware configuration shown in FIG. 2. As in FIG. 10, the client 1a is provided with the a DNS server designation section 41, an output section 42, an input section 43, and a resolver 44. The client 1a stores routing tables 34 shown in FIGS. 6A and 6B in a storage unit such as a hard disk.

The DNS server designation section 41 designates the DNS server 6 or 7 with reference to address information included in the query data and the routing table 34, to forward a request for resolving a domain name or an IP address. The output section 42 outputs query data about a domain name or IP address to the designated DNS server 6 or 7. The input section 43 inputs the domain name or IP address according to a user's operation. The resolver 44 makes a request for the name resolution based on the data inputted by the input section.

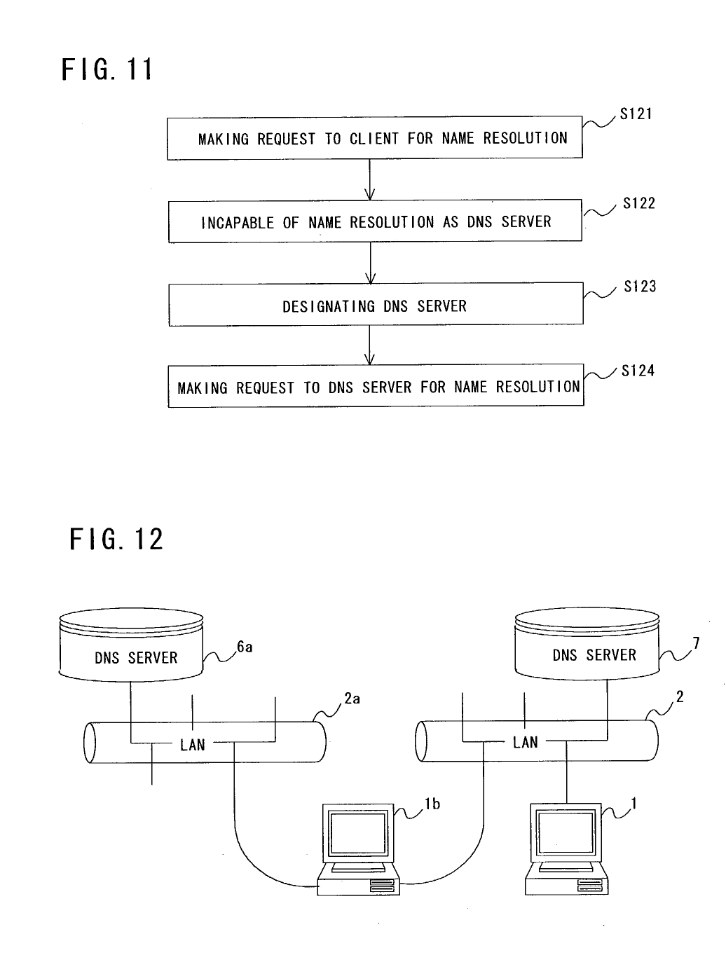

FIG. 11 is a flowchart showing a process in the client 1a for transmitting the query data requesting the name resolution. The client 1a sets itself as a DNS server on a TCP/IP protocol.

In the client 1a, when a domain name, for example, is inputted on the browser via an external input unit, it is then inputted into the resolver 44 via the input section 43, as shown in FIG. 11. Since the client 1a is set to the DNS server, the resolver 44 queries the client 1a about the domain name (S121). Then, the data including the domain name are transmitted to the DNS server designation section 31 from the resolver 44.

The client 1a performs the name resolution of the domain name. Being incapable of resolving the domain name (S122), the DNS server designation section 31 designates the DNS server to which the name resolution is to be allocated (S123). The DNS server designation section 41 compares the domain name sent from the resolver 44 with the domain names in the routing table 34, determines the DNS server associated with the domain name, and outputs address information of the DNS server to the output section 42. The DNS server designation section 41 carries out the basically same processing as the DNS server designation section 31 explained with reference to FIG. 5.

The output section 42 transmits the query data whose sender is the client 1a and whose destination is the designated DNS server to the designated DNS server (S124). The query data are transmitted to the designated DNS server via the router 3a.

Then, as is conventional, the DNS server resolves the domain name in the query data, and transmits response data including an IP address of the host to the client 1a.

As explained above, the client 1a designates the DNS server capable of resolving the name, refereeing to the domain name or the IP address included in the request, and the routing table 34. The client 1a is thus capable of working as a routing device. Therefore, it is possible to resolve names without fail, not distinguishing virtual domain names or private IP addresses from actual domain names or public IP addresses.

Another configuration example of a DNS relay system employing the data routing device according to the present invention will be explained with reference to FIG. 12. The explanation will be given of a DNS relay system applying the system shown in FIG. 9. FIG. 12 is a schematic diagram showing another configuration example of the DNS relay system according to the present invention. As shown in FIG. 12, the DNS relay system includes the clients 1 and 1a, the router 3a, and the DNS servers 6a and 7.

In FIG. 12, the same elements as in FIG. 9 are denoted by the same reference symbols and redundant description will be omitted. The client 1 and the DNS server 6a in FIG. 12 can communicate with each other through the same computer network. The computer network is LAN or WAN, for example, and it is LAN 2a in the system shown in FIG. 12.

The client 1b stores the routing tables shown in FIGS. 6A and 6B. Since the client 1b is connected to the LANs 2 and 2a, the routing table stores a virtual domain name of the DNS server 6a used on the LAN 2a, and its corresponding IP address.

In the DNS relay system shown in FIG. 12, the client 1a designates the DNS server 6 or 7 with reference to the routing table 34, in accordance with the DNS server designating program. Therefore, it is possible to resolve names without fail, not distinguishing virtual domain names or private IP addresses from actual domain names or public IP addresses.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A data routing device capable of routing requests to plural resolution systems which supply address information corresponding to another address information on a network, comprising:
an obtaining unit of obtaining a request including first address information on a network and demanding second address information corresponding to the first address information;
a storing unit of storing resolution system information regarding the plural resolution systems and associated with address information on a network;
a determining unit of determining a resolution system to which the request is to be forwarded out of the plural resolution systems, based on the first address information included in the request and the resolution system information stored in the storing unit; and
a transmitting unit of transmitting the request to the designated resolution system.

2. A data routing device according to claim 1, wherein one of the first address information and the second address information is a domain address and the other is an IP address.

3. A data routing device according to claim 1, wherein the plural resolution systems include a DNS server performing name resolution between a domain address and an IP address.

4. A data routing device according to claim 1, wherein the storing unit further comprises:
first resolution system information associated with a domain address or an IP address on a network using a virtual domain; and
second resolution system information associated with a domain address or an IP address on a network using an actual domain.

5. A data routing device according to claim 4, wherein the first resolution system comprises a name server to perform name resolution in the virtual domain; and the second resolution system comprises a name server to perform name resolution in the actual domain.

6. A data routing device according to claim 1, wherein the first address information and the second address information indicate the same node.

7. A data routing device according to claim 1, wherein the resolution system information include address information of a name server to perform name resolution.

8. A data routing device according to claim 1, wherein the storing unit includes first resolution system information associated with a local address, and second resolution system information associated with a global address.

9. A data routing device according to claim 8, wherein the first resolution system information include address information of a name server to perform name resolution on the local address; and the second resolution system information include address information of a name server to perform name resolution on the global address.

10. A method for determining a destination of a request, comprising:
a step of storing resolution system information regarding plural resolution systems to supply address information corresponding to another address information on a network;
a step of obtaining a request including first address information on a network and demanding second address information corresponding to the first address information; and
a step of determining a resolution system to which the request is to be forwarded out of the plural resolution systems, based on the first address information included in the obtained request, and the stored resolution system information.

11. A method according to claim 10, wherein the step of storing comprises a step of storing first resolution system information associated with a domain address on a network using a virtual domain or to an IP address, and second resolution system information associated with a domain address on a network using an actual domain or to an IP address.

12. A computer program product, in a computer-readable medium, for a computer to carry out a processing to determine a destination of a request, comprising:
instruction for storing resolution system information regarding plural resolution systems to supply address information corresponding to another address information on a network;
instruction for obtaining a request including first address information on a network and demanding second address information corresponding to the first address information; and
instruction for determining a resolution system to which the request is to be forwarded out of the plural resolution systems, based on the first address information included in the obtained request and the stored resolution system information.

13. A computer program product according to claim 12, wherein the step of storing comprises:
a step of storing first name server address information associated with a domain address or an IP address on a network using a virtual domain as resolution system information; and
a step of storing second name server address information associated with a domain address or an IP address on a network using an actual domain as resolution system information.
